(19) United States
(12) Patent Application Publication
(10) Pub. No.: US 2021/0048185 A1
(43) Pub. Date: Feb. 18, 2021

(54) THERMALLY CONDUCTIVE COATINGS

(71) Applicant: SABIC GLOBAL TECHNOLOGIES B.V., Bergen op Zoom (NL)

(72) Inventors: Remesh KUZHIKKALI, Bangalore (IN); Arunachala PARAMESHWARA, Bangalore (IN); Venkatesha NARAYANASWAMY, Bangalore (IN); Franciscus Petrus Maria MERCX, Bergen op Zoom (NL); François Guillaume Sébastien COURTECUISSE, Bergen op Zoom (NL); Hans-Otto SCHLOTHAUER, Duesseldorf (DE)

(21) Appl. No.: 17/049,425

(22) PCT Filed: Apr. 30, 2019
(86) PCT No.: PCT/IB2019/053549

§ 371 Date: Oct. 21, 2020

Related U.S. Application Data
(60) Provisional application No. 62/665,242, filed on May 1, 2018.

(51) Int. Cl. F21V 29/70; F21V 29/89

(52) U.S. Cl. CPC F21V 29/70; F21V 29/87; F21V 29/89

(57) ABSTRACT

Various embodiments disclosed relate to economic thermally conductive coatings. The present invention includes metal coatings suitable for use with luminaires that facilitate heat dissipation. The invention further includes a device comprising a substrate comprising at least one LED; a heat sink comprising a non-thermally conducting plastic component having an inner surface and an outer surface; and a thermally conductive coating in thermal communication with the substrate on at least the inner surface of the plastic

### BACKGROUND

Recent trends in the light emitting diode (LED) lighting manufacturing industry relate to replacement of the metal housing in LED lights with thermoplastics (e.g., thermally conductive thermoplastics). Thermoplastics offer advantages in design, manufacturability, and product differentiation. Additionally, thermoplastics can help with weight savings, design flexibility, part integration, and the elimination of secondary operations such as drilling, tapping, painting or powder coating.

However, due to its lower thermal conductivity, a thermoplastic heat sink poses a greater challenge in managing heat. Some factors that can affect the efficiency/effectiveness of heat transfer include: (i) the heat transfer coefficient, (ii) the thermal conductivity of heat sink material, (iii) the area of contact of the heat source with the heat sink, and (iv) the heat sink surface area exposed to the atmosphere. Heat transfer coefficients can be increased by methods that increase airflow by forced convection by fans, blowers etc. The surface area can also be increased by designing suitable fins in the housing. However, such methods add complexity and cost to the system. It is therefore desirable to devise a plastic solution that meets performance criteria with respect to mechanical and thermal management when the heat sink is also used as a housing.

### SUMMARY OF THE INVENTION

The disclosure provides, among other things, a device including a substrate comprising at least one LED, a non-thermally conducting plastic heat sink having an inner surface and an outer surface, a thermally conductive coating on at least the inner surface of the heat sink, wherein the inner surface of the heat sink is in thermal communication (e.g., in direct contact) with the substrate.

Methods for making such devices are also presented herein. The method includes providing a non-thermally conducting plastic heat sink having an inner surface and an outer surface, wherein the heat sink has a thermally conductive layer on at least the inner surface of the heat sink; and connecting the heat sink with a substrate comprising at least one LED.

In various embodiments, the disclosure provides a device including a substrate comprising at least one LED, a heat sink comprising a non-thermally conducting plastic component with a thermal conductivity ranging from 0.1 W/mK to 0.5 W/mK, having an inner surface and an outer surface, and a conductive coating (such as a metal or non-metal coating, e.g., an aluminum or copper coating) in thermal communication with the substrate on at least the inner surface of the plastic component, wherein the aluminum or copper coating is in direct contact with the substrate.

Advantageously, devices disclosed herein provide improved heat transfer capabilities through the use of a thermally conductive coating at the interface between the plastic heat sink and, for example, a PCB (printed circuit board) such that the effective thermal conductivity of the heat sink is enhanced. This arrangement provides for improved heat transfer and better thermal management of a device or system that incorporates the features described herein.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments of the present invention.

FIG. 1A is a top perspective view of a circular housing (100) having a first major surface (110), in accordance with various embodiments.

FIG. 1B is a bottom perspective view of a circular housing having (120) a second major surface (140), in accordance with various embodiments. FIG. 1B shows raised structures (130).

FIG. 2A is a top perspective view of an octagonal housing (200) having a first major surface (210), in accordance with various embodiments.

FIG. 2B is a bottom perspective view of an octagonal housing (220) having a second major surface (240), in accordance with various embodiments. The housing in FIG. 2B shows raised fin structures (230).

FIG. 3A is a perspective view of bottom part of an octagonal housing as in, FIG. 2B having a second major surface (310) as the heat sink where the thermally conducting material is deposited only on portions having a hash pattern, in accordance with various embodiments. Portions of the second major surface (300) that lack a hash pattern also do not have any thermally conducting material deposited thereon.

FIG. 3B is a perspective view bottom part of an octagonal housing as in FIG. 2B, having a second major surface as the heat sink where the thermally conducting material is deposited on the all of the second major surface (320), in accordance with various embodiments.

FIG. 4 is a schematic of a device with heat source and locations where the temperature levels were sampled.

FIG. 5 is a chart showing temperature decreases by region when a copper metal coating is used on the heat sink and with a plastic having on metal coating, in accordance with various embodiments. The numbered locations in FIG. 5 correspond to the numbers in FIG. 4.

FIG. 6 is a chart of the thermal conductive ability of a variety of materials used as coatings on a housing to dissipate heat from a PCB containing LEDs, and of uncoated configurations.

FIG. 7 is a baseline design of a heat sink used for thermal conductivity simulations.

FIG. 8 is a thermal map of a simulation with an uncoated device, showing a maximum device temperature (Tₘₐₓ) of 95° C.

FIG. 9 is a thermal map of a simulation with a device coated with a thermal interface material (TIM) having a thermal conductivity of 1.8 W/mK and 50 micron thickness, and showing a maximum device temperature (Tₘₐₓ) of 87° C.

FIG. 10 is a thermal map of a simulation with a device coated with aluminum, showing a maximum device temperature (Tₘₐₓ) of 83° C.

FIG. 11 is a thermal map of a simulation with a device coated with copper, showing a maximum device temperature (Tₘₐₓ) of 82° C.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to 5%” or “0.1% to 5%” should be interpreted to include not just 0.1% to 5%, but also the individual values (e.g., 1%, 2%, 3%, and 4%) and the sub-ranges (e.g., 0.1% to 0.5%, 1.1% to 2.2%, or 3.3% to 4.4%) within the indicated range. The statement “X to Y” has the same meaning as “X to Y,” unless indicated otherwise. Likewise, the statement “X, Y, or Z” has the same meaning as “X, Y, or Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least 50%, 60%, 70%, 80%, 90%, 95%, 96%, 97%, 98%, 99%, 99.5%, 99.9%, 99.99%, or at least 99.999% or more, or 100%. The term “substantially free of” as used herein can mean having none or having a trivial amount of, such that the amount of material present does not affect the material properties of the composition including the material, such that the composition is 0 wt % to 5 wt % of the material, or 0 wt % to 1 wt %, or 5 wt % or less, or less than, equal to 4.5 wt %, 4, 3.5, 3, 2.5, 2, 1.5, 1, 0.9, 0.8, 0.7, 0.6, 0.5, 0.4, 0.3, 0.2, 0.1, 0.01, or 0.001 wt % or less. The term “substantially free of” can mean having a trivial amount of, such that a composition is 0 wt % to 5 wt % of the material, or 0 wt % to 1 wt %, or 5 wt % or less, or less than or equal to 4.5 wt %, 4, 3.5, 3, 2.5, 2, 1.5, 1, 0.9, 0.8, 0.7, 0.6, 0.5, 0.4, 0.3, 0.2, 0.1, 0.01, or 0.001 wt % or less, or 0 wt %, or any range between these values.

The term “coating” as used herein refers to a continuous or discontinuous layer of material on the coated surface, wherein the layer of material can penetrate the surface and can fill areas such as pores, wherein the layer of material can have any three-dimensional shape, including a flat or curved plane. In one example, a coating can be formed on one or more surfaces, any of which may be porous or nonporous, by immersion in a bath of coating material.

The term “surface” as used herein refers to a boundary or side of an object, wherein the boundary or side can have any perimeter shape and can have any three-dimensional shape, including flat, curved, or angular, wherein the boundary or side can be continuous or discontinuous. The term “thermal communication” as used herein means that thermal radiation can be transferred from one area or source to another area.

In various embodiments, the invention provides a device that includes a substrate comprising at least one LED, a non-thermally conducting plastic heat sink having an inner surface and an outer surface, a thermally conductive coating on at least the inner surface of the heat sink, wherein the inner surface of the heat sink is in thermal communication with the substrate.

The thermally conductive coating can be a metal coating. The metal can include substantially pure metals such as zinc, copper, silver, gold, platinum, aluminum, as well as alloys of these metals, such as brass and bronze, and combinations of these metals and/or alloys. The thermally conductive coating can contain thermally conductive non-metal substances. Examples of conductive non-metal substances can include graphene, boron nitride (amorphous and crystalline), carbon nanotubes (e.g., single-walled carbon nanotubes, and multi-walled carbon nanotubes). The thermally conductive coating can also contain a mixture of metal and non-metal thermally conductive substances in any suitable ratio. In various embodiments, the metal to non-metal ratio can be 99.9:0.1, 99.75:0.25, 99.5:0.5, 99:1, 98:2, 97:3, 96:4, 95:5, 94:6, 93:7, 92:8, 91:9, 90:10, 80:20, 70:30, 60:40, 50:50, 40:60, 30:70, 20:80, 10:90, 9:91, 8:92, 7:93, 6:94, 5:95, 4:96, 3:97, 2:98, 1:99, 0.5:99.5, 0.25:99.75, or 0.1:99.9.

A non-thermally conductive plastic, in various embodiments, is a thermoplastic that has a thermal conductivity below 0.7 watts per meter Kelvin (W/mK). In various embodiments, a non-thermally conductive plastic has a thermal conductivity below 0.65 W/mK, 0.5 W/mK, 0.45 W/mK, 0.40 W/mK, 0.35 W/mK, 0.30 W/mK, 0.25 W/mK, 0.20 W/mK, 0.15 W/mK, or 0.10 W/mK, or any range between these values. In various embodiments, the non-thermally conductive plastic has a thermal conductivity between 0.7 and 0.1 W/mK, between 0.65 W/mK and 0.15 W/mK, between 0.55 W/mK and 0.25 W/mK, or between 0.45 W/mK and 0.35 W/mK. In various embodiments, the thermal conductivity of the plastic is between 0.1 W/mK and 0.5 W/mK.

In various embodiments, the substrate is a circuit board. The circuit board can be a printed circuit board (PCB) having a conventional glass epoxy insulating substrate and conductive tracks, pads, or other features made from, etched copper. In various embodiments, the circuit board comprises a single layer (also known as single sided), where only a single copper layer is present in the PCB. The substrate can have a single LED or a plurality of LEDs, such that the substrate can be an LED array. For example, the substrate can contain 1, 2, 3, 4, 5, 6, 7, 8, 9, 10, 15, 20, 25, 30, 35, 40, 45, 50, 55, 60, 65, 70, 75, 80, 85, 90, 85, 100 or more LEDs. The LED array can have any suitable pattern as determined by the intended lighting application, including, for example, circular patterns, grid patterns, and line patterns.

In various embodiments, the thermally conductive coating can decrease the maximum temperature of a PCB by 1 to 20° C., 2 to 19° C., 3 to 18° C., 4 to 17° C., 5 to 16° C., 6 to 15° C., 7 to 14° C., 8 to 13° C., or 9 to 12° C. In some embodiments, the thermally conductive coating can decrease the maximum temperature of a PCB by 1° C., 2° C., 3° C., 4° C.,5° C., 6° C., 7° C., 8° C., 9° C., 10° C., 11° C., 12° C., 13° C., 14° C., 15° C., 16° C., 17° C., 18° C., 19° C., 20° C., or any range or sub-range between these values.

The device can be a luminaire. The luminaire can be suitable for indoor use, outdoor use, or a mixture of indoor and outdoor applications.

The non-thermally conducting plastic can be a single plastic or a blend of plastics. Suitable plastics include acrylonitrile butadiene styrene, polystyrene, polyvinyl chloride, polycarbonate, polypropylene, polyethylene terephthalate, low density polyethylene, high density polyethylene, or mixtures thereof any of these plastics. In one example, the plastic is acrylonitrile butadiene styrene. The non-thermally conducting plastic can also include thermoset plastics, such as, without limitation, acrylic resins, epoxy functional resins, polyurethane resins, phenolic resins, and co-polymers thereof.

In various embodiments, substantially all of the thermally conductive coating on the inner surface on non-thermally conductive component of the heat sink is in thermal communication with the substrate. For example, a metal coating can be in thermal communication with the substrate, with or without any intervening substance, such as a thermal paste, between the metal coating and the substrate. Similarly, a thermally conductive non-metal coating can be in thermal communication with the substrate. For example, thermally conductive coating can be in contact with the side of a PCB that does not contain copper traces or other conducting features. In some examples, the metal coating can be in contact with the side of a PCB that contains copper traces or other conducting features.

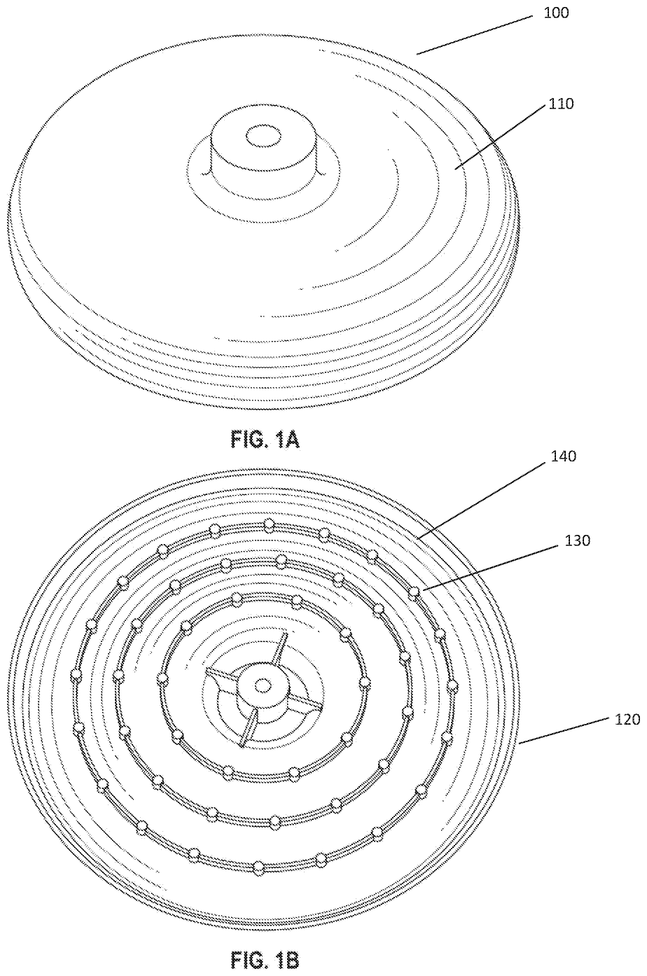

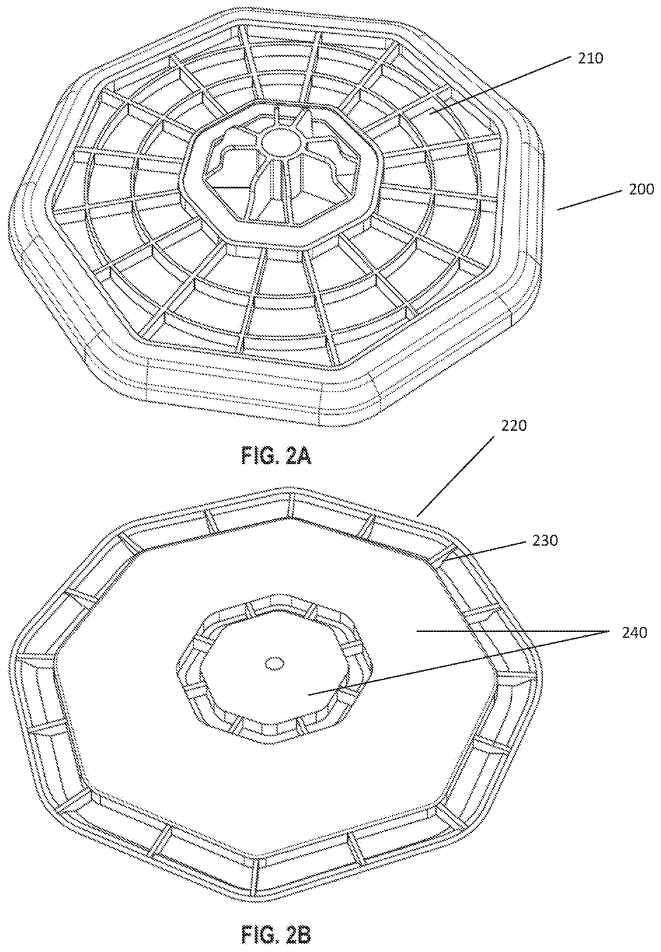

The device can further include a housing having a first major surface and a second major surface, where the heat sink is formed on a portion of the housing. The housing can be any suitable ornamental design, and can include designs that have two pieces that can be attached together to form an enclosure that protects the at least one LED, the substrate, and the heat sink from weather conditions such as sun, wind, and rain. Housings having two pieces that can be connected or attached together are shown in FIGS. 1A-1B and 2A-2B. FIGS. 1A and 1B show top and bottom portions, respectively, of a circular-shaped housing. FIG. 1A is a top perspective view of a circular housing (100) having a first major surface (110). The opposite side of circular housing (100) is a first opposite surface that faces the interior of the device formed when circular housing (100) is attached to circular housing (120). FIG. 1B is a bottom perspective view of a circular housing having (120) a second major surface (140). The opposite side of housing (120) is a second opposite surface that faces the exterior of the device formed when circular housing (100) is attached to circular housing (120). FIG. 1B shows raised structures (130) that can be used to support any suitable structures, such as a PCB or heat sink. The top circular housing (100) and the bottom circular housing (120) can be connected or attached together by any suitable means, including mechanical fasteners and adhesive. When connected or attached together, the first opposite surface of circular housing (100) and the second major surface of circular housing (120) face each other and both are in the interior of the device and not exposed to the outside environment. In various embodiments, the top circular housing (100) and the bottom circular housing (120) are connected or attached together such that the edges of each respective housing are aligned to overlap without any portion sticking out past the edge of either housing.

FIGS. 2A and 2B show top and bottom portions, respectively, of an octagonal-shaped housing. FIG. 2A is a top perspective view of an octagonal housing (200) having a first major surface (210). The opposite side of octagonal housing (200) is a first opposite surface that faces the interior of the device formed when octagonal housing (200) is connected or attached to octagonal housing (220). FIG. 2B is a bottom perspective view of an octagonal housing (220) having a second major surface (240), in accordance with various embodiments. The opposite side of octagonal housing (220) is a second opposite surface that faces the exterior of the device formed when octagonal housing (200) is connected or attached to octagonal housing (220). The housing in FIG. 2B shows raised fin structures (230). FIG. 2A shows the first major surface (210) of the housing, which faces the exterior environment. FIG. 2B shows the second major surface (240) of the housing. The second major surface (240) in FIG. 2B is formed on the second piece of a two-piece housing, and is located in the interior formed when the two-pieces are joined. The second major surface (240) is not exposed to the outdoor environment. When the housing is a two-piece design, the top and bottom portions of the housing can be joined or bonded together by using, for example, an adhesive or a mechanical fastener. When connected or attached together, the first opposite surface of octagonal housing (200) and the second major surface of octagonal housing (220) face each other and both are in the interior of the device and not exposed to the outside environment. In various embodiments, the top circular housing (200) and the bottom circular housing (220) are connected or attached together such that the edges of each respective housing are aligned to overlap without any portion sticking out past the edge of either housing.

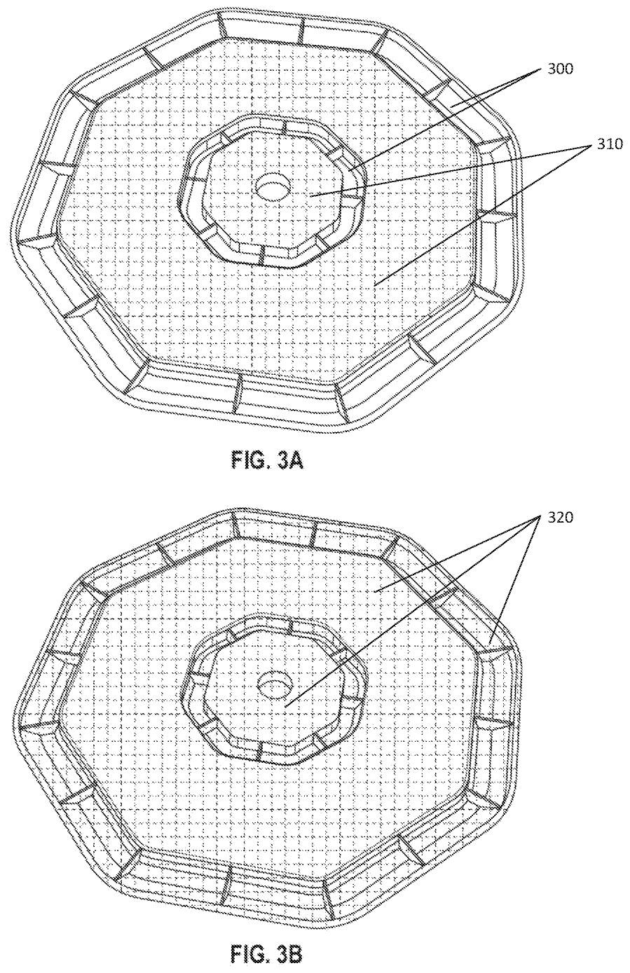

In various embodiments, the heat sink can be one housing piece in a device constructed from a two-piece housing. For example, the heat sink can be circular housing (120) or octagonal housing (220), but a structure that functions as a heat sink can be any suitable portion of the device described herein. As an example, the inner surface of the heat sink can be formed on any second major surface described herein. In various embodiments, the inner surface of the heat sink is the second major surface. FIG. 3A is a perspective view of bottom part of an octagonal housing as in FIG. 2B, having a second major surface (310) as the heat sink where the thermally conducting material is deposited only on portions having a hash pattern. FIG. 3A shows a thermally conductive (depicted by the hash pattern) coating formed on the inner surface of the heat sink. In FIG. 3A, the thermally conductive coating is formed on the substantially flat surfaces of the heat sink. Portions of the second major surface (300) that lack a hash pattern also do not have any thermally conducting material deposited thereon.

FIG. 3B is a perspective view bottom part of an octagonal housing as in FIG. 2B, having a second major surface as the heat sink where the thermally conducting material is deposited on the all of the second major surface (320). In FIG. 3B, the thermally conductive coating is formed on the entire surface of the heat sink. In FIGS. 3A and 3B, a substrate placed onto the surface of the heat sink would be in contact with the substantially flat portions of the heat sink. In various embodiments, the inner surface of the heat sink is substantially flat.

The thermally conductive coating can have an average thickness of 1 mm to 100 mm. The metal coating can have a thickness of 1 millimeter (mm) to 100 mm, 2 mm to 98 mm, 3 mm to 97 mm, 4 mm to 96 mm, 5 mm to 95 mm, 6 mm to 94 mm, 7 mm to 93 mm, 8 mm to 92 mm, 9 mm to 91 mm, 10 mm to 90 mm, 20 mm to 80 mm, 30 mm to 70 mm, 40 mm to 60 mm, or any range or sub-range in between.

The housing can comprise a plurality of raised structures. The raised structures can have any suitable shape or pattern, including concentric circles, concentric circles having regularly spaced pegs along the circumference of the circles, lines, ribs, fins, regular polygons, or combinations thereof. The raised structures can be formed on any exterior surface of the housing, such as the first major surface described herein. The raised structures can be formed on any interior surface of the housing, such as the second major surface described herein. The height of the raised structures can be from 1 mm to 40 mm, 5 mm to 35 mm, 10 mm to 30 mm, 15 mm to 25 mm, or any range or sub-range between these values. The raised structures can be 1 mm, 2 mm, 3 mm, 4 mm, 5 mm, 10 mm, 15 mm, 20 mm, 25 mm, 30 mm, 35 mm, 40 mm, or 45 mm in height. In FIG. 1B, the raised structures are a series of concentric circles with regularly spaced pegs along the circumferences of the circles is shown. When a heat sink is placed on the raised pegs, the heat dissipating properties of the heat sink can be enhanced due to increased airflow between and around the pegs. FIG. 2B shows a series of ribs along the circumference of the heat sink.

In various embodiments, the invention provides a device including a substrate comprising at least one LED, a non-thermally conducting plastic heat sink having an inner surface and an outer surface and a thermal conductivity ranging from 0.1 W/mK to 0.5 W/mK, an aluminum or copper coating on the inner surface of the heat sink, wherein the inner surface of the heat sink is in direct contact and thermal communication with the substrate.

In various embodiments, a method of making a luminaire, includes forming a non-thermally conducting plastic heat sink having an inner surface and an outer surface, depositing a thermally conductive layer on at least the inner surface of the heat sink, contacting the heat sink with a substrate having at least one LED.

In various embodiments, the device further includes enclosing the substrate in a housing. The housing can be any suitable ornamental design described herein. The thermally conductive layer, in various embodiments, can be a metal layer.

In various embodiments, the forming includes injection molding. When the housing is constructed from two pieces, as in FIGS. 1A-1B and 2A-2B, both the portion of the housing having the first major surface and the portion of the housing having the second major surface can be made by injection molding.

In various embodiments, the metal layer can be deposited using vacuum metallization, arc and flame spraying or plating, or in-mold decoration. In various embodiments, the metal layer includes aluminum, copper, or combinations thereof.

In various embodiments, the housing includes a plurality of raised structures, which can be any of the raised structures described herein. In various embodiments, the inner surface of the heat sink is in direct contact with the substrate. In various embodiments, the substrate includes a printed circuit board.

In various embodiments, the inventive method of making a device, includes forming a non-thermally conducting plastic heat sink having an inner surface and an outer surface, depositing an aluminum or copper layer on at least the inner surface of the heat sink, contacting the heat sink and a substrate includes at least one LED, and enclosing the substrate in a housing.

### Examples

Various embodiments of the present invention can be better understood by reference to the following Examples which are offered by way of illustration. The present invention is not limited to the Examples given herein.

### Efficacy of a Metal Coating on Thermoplastics in Thermal Management

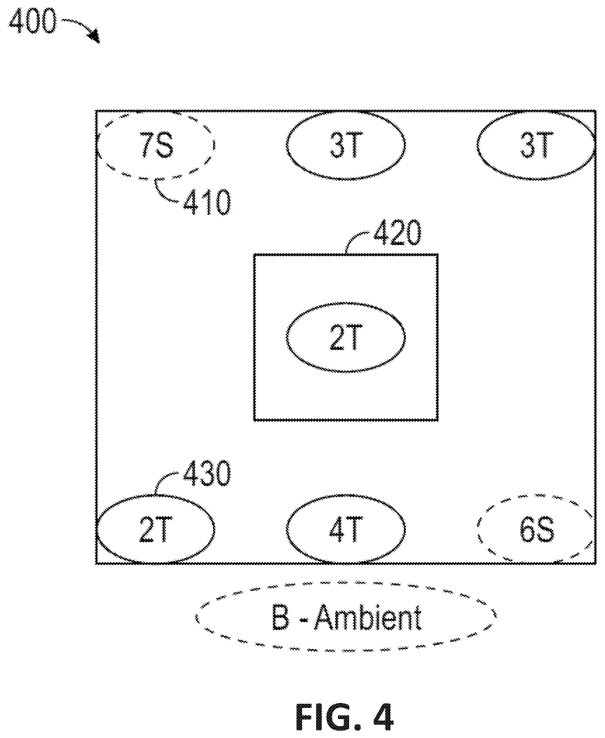

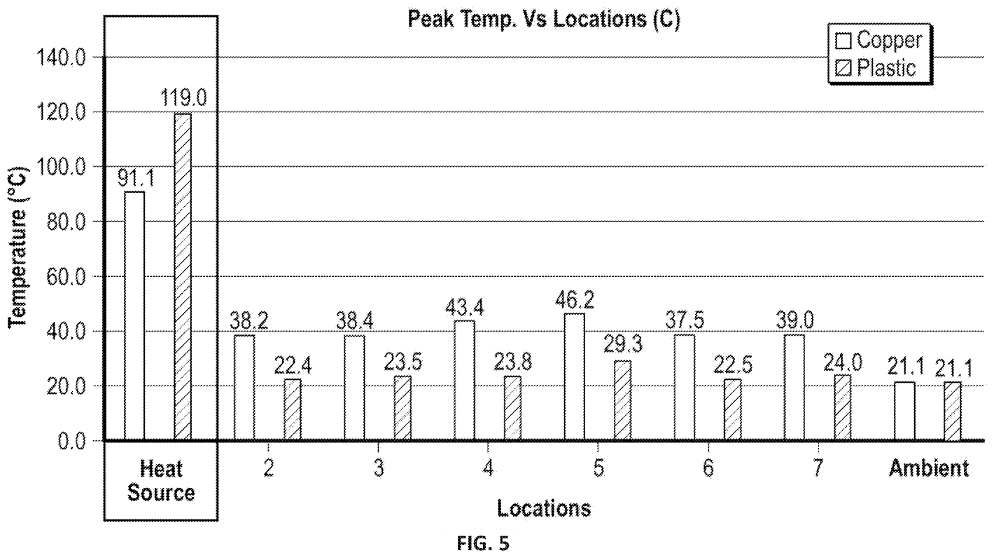

To evaluate the efficacy of a metal coating on thermoplastic, an experiment is conducted on a bare and a copper-coated thermoplastic acrylonitrile butadiene styrene (ABS) CYCOLAC™ plate. The thermal conductivity of ABS is nearly 0.2 W/mK and that of copper is 385 W/mK. A heat source of 5 W power is placed at the center of the plates as shown in FIG. 4. Temperatures are measured at different locations with thermocouples and IR camera to evaluate and compare the thermal performance of two ABS samples without and with coating. The chart in FIG. 5 shows that the peak temperature (near the heat source) has reduced considerably in the case of a copper-coated ABS plate. This decrease in peak temperature is attributed to the enhanced in-plane thermal conductivity of copper-coated ABS plate. Higher in-plane thermal conductivity helps to spread heat away from the heat source, which results in reduced temperatures near heat source. However, locations away from heat source receive augmented amount of heat compared to plane plates and shows elevated temperatures. From a performance perspective of LED chips (heat source), lower temperatures can enhance the life, light output, and color stability of devices using heat sinks with metal coatings.

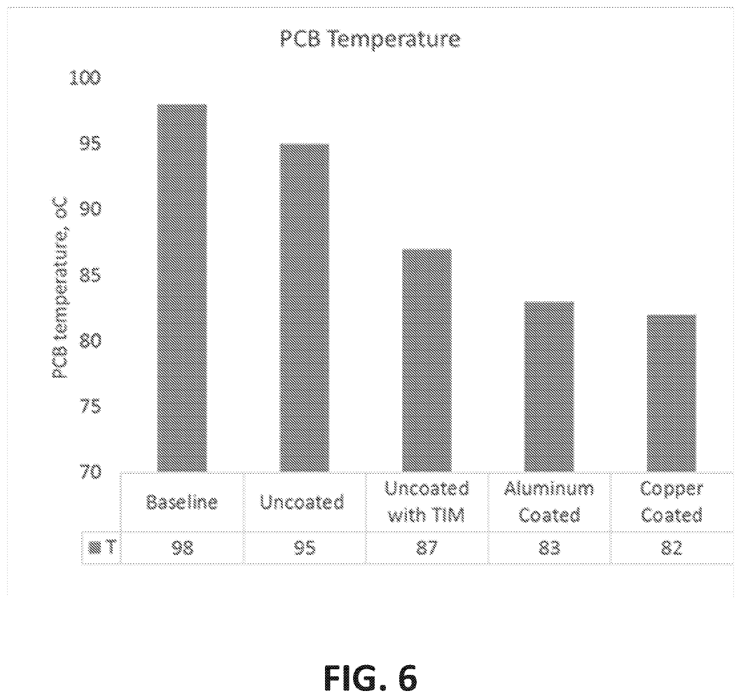

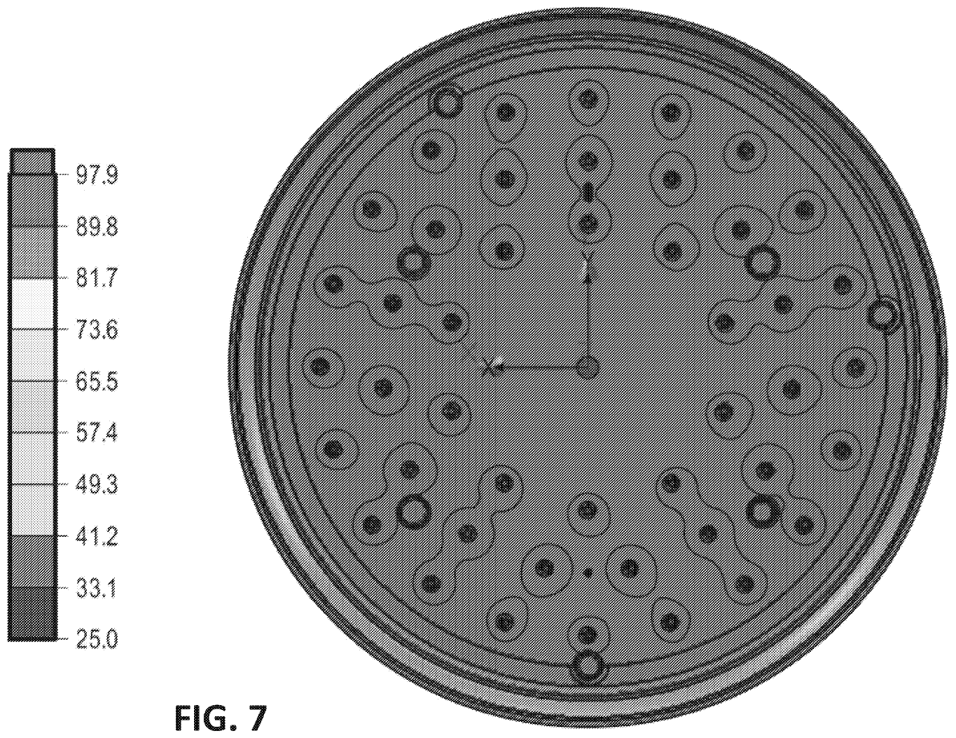

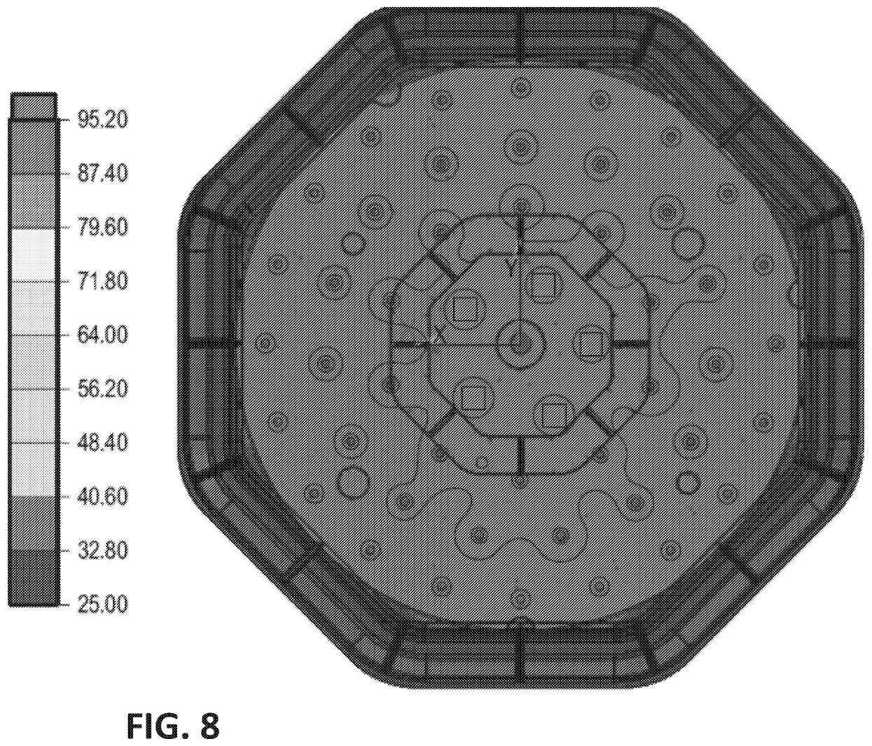

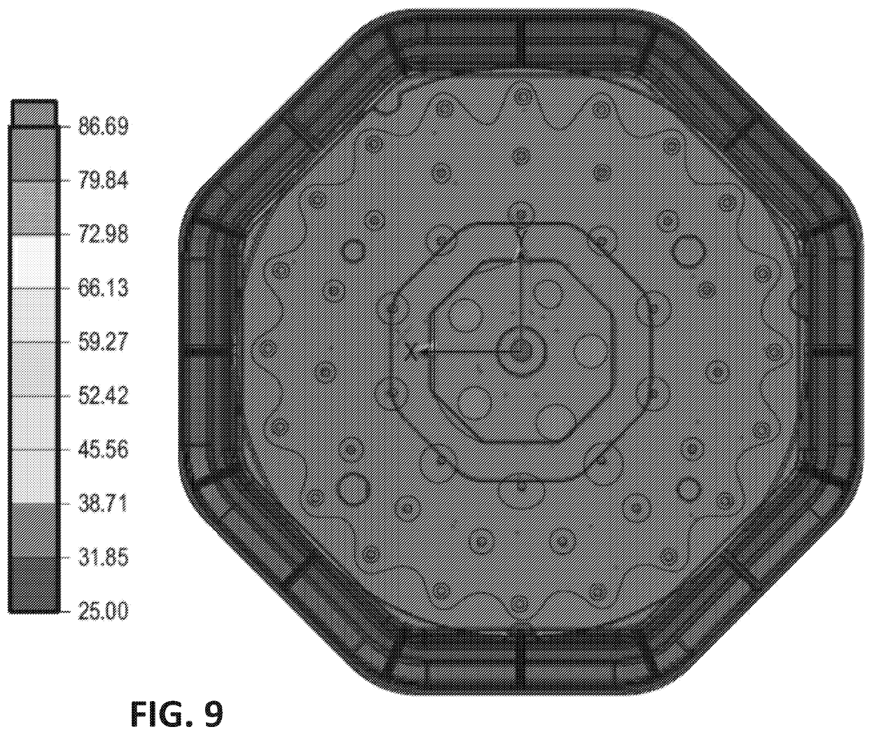

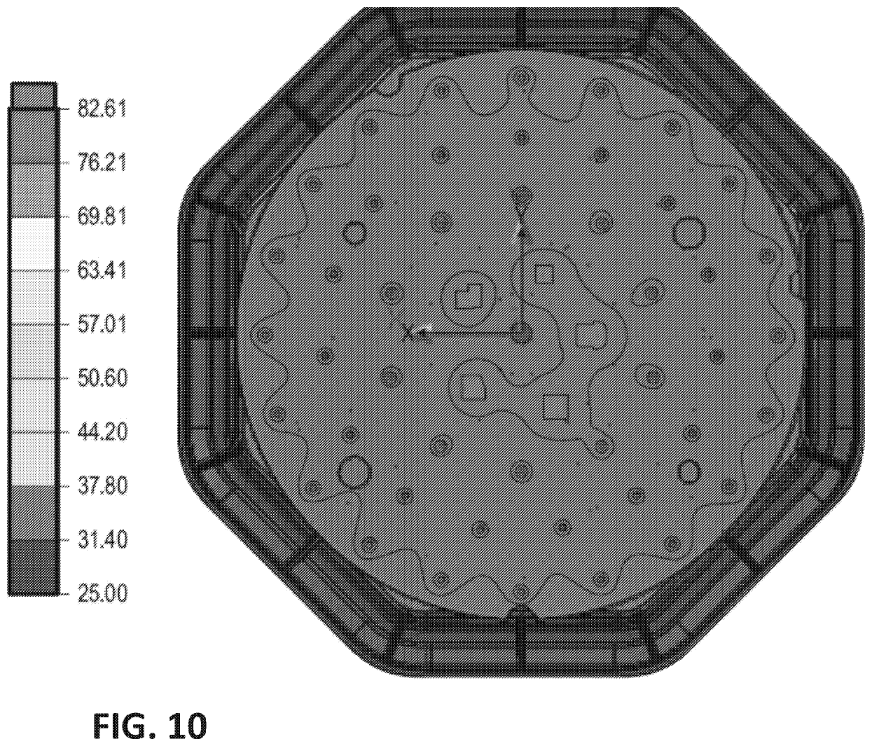

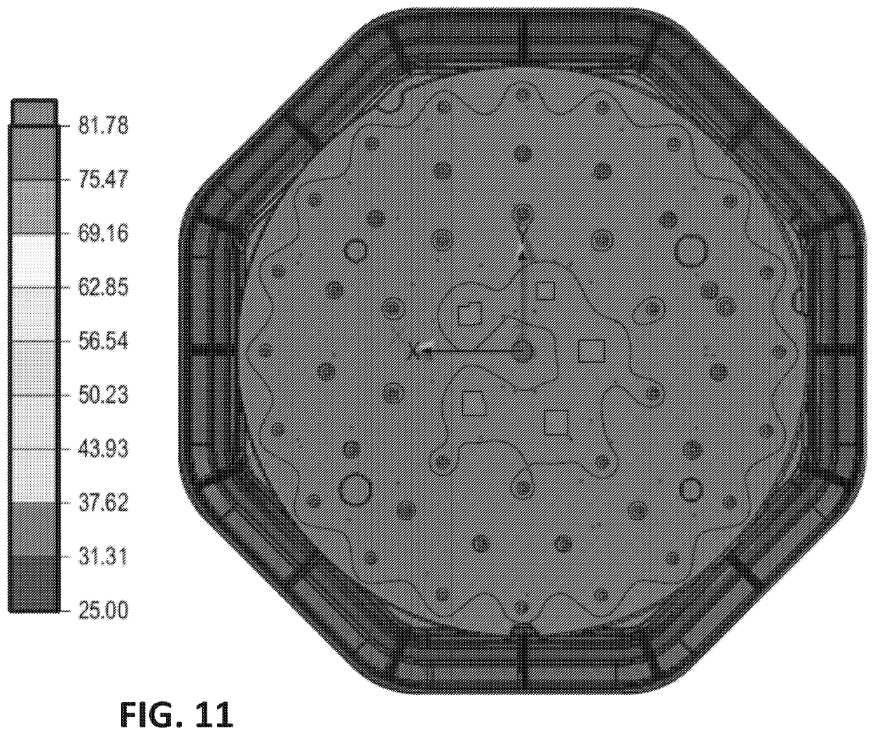

The thermal performance comparison of configurations having a PCB and LED, with and without metal coating, are shown in FIG. 6. The metal coating significantly reduces PCB temperatures in comparison to uncoated configurations and configurations that use thermal interface material (TIM). The data in FIG. 6 show that a thermally conducting layer, such as an aluminum layer or a copper layer, can significantly decrease the maximum temperature in a PCB at an LED interface. For example, an aluminum coating can decrease the maximum temperature of a PCB by up to 12° C., and a copper coating can decrease the maximum temperature of a PCB by up to 13° C. The individual simulations corresponding to the results shown in FIG. 6 and showing the heat distribution throughout the device are in FIGS. 7-11.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

The following exemplary aspects are provided, the numbering of which is not to be construed as designating levels of importance:

Aspect 1: A device comprising: a substrate comprising at least one LED; a heat sink comprising a non-thermally conducting plastic component having an inner surface and an outer surface; and a thermally conductive coating in thermal communication with the substrate on at least the inner surface of the plastic component.

Aspect 2: The device of Aspect 1, wherein the thermally conductive coating comprises a metal, thermally conductive non-metal substances, or a mixture of metal and non-metal thermally conductive substances.

Aspect 3: The device of any of the preceding aspects, wherein the thermally conductive coating comprises at least one of zinc, copper, silver, gold, platinum, aluminum, alloys of these metals, or combinations of these metals.

Aspect 4: The device of any of the preceding aspects, wherein the thermally conductive coating comprises at least one of graphene, boron nitride, or carbon nanotubes.

Aspect 5: The device of any of Aspects 1-3, wherein the thermally conductive coating is a metal coating.

Aspect 6: The device of any of the preceding aspects, wherein substantially all of the thermally conductive coating on the inner surface of the heat sink is in thermal communication with the substrate.

Aspect 7: The device of any of the preceding aspects, wherein the substrate is a circuit board.

Aspect 8: The device of Aspect 7, wherein the circuit board comprises a single layer.

Aspect 9: The device of any of the preceding aspects, wherein the thermally conductive coating comprises copper or aluminum.

Aspect 10: The device of any of the preceding aspects, wherein thermally conductive coating has an average thickness of 1 μm to 100 μm.

Aspect 11: The device of any of the preceding aspects, further comprising a housing having a first major surface and a second major surface, and wherein the heat sink is formed on a portion of the housing.

Aspect 12: The device of aspect 11, wherein the housing comprises a plurality of raised structures.

Aspect 13: The device of any of the preceding aspects, wherein the substrate comprises an LED array.

Aspect 14: The device of any of the preceding aspects, wherein the device is a luminaire.

Aspect 15: The device of any of the preceding aspects, wherein the thermal conductivity of the plastic is 0.01 W/mK to 0.7 W/mK.

Aspect 16: The device of any of the preceding aspects, wherein the thermal conductivity of the plastic is 0.1 W/mK to 0.5 W/mK.

Aspect 17: The device of any of the preceding aspects, wherein the plastic is acrylonitrile butadiene styrene.

Aspect 18: The device of any of the preceding aspects, wherein the inner surface of the heat sink is in direct contact with the substrate.

Aspect 19: The device of any of the preceding aspects, wherein the inner surface of the heat sink is substantially flat.

Aspect 20: A device comprising: a substrate comprising at least one LED; a heat sink comprising a non-thermally conducting plastic component with a thermal conductivity ranging from 0.1 W/mK to 0.5 W/mK, having an inner surface and an outer surface; and an aluminum or copper coating in thermal communication with the substrate on at least the inner surface of the plastic component; wherein the aluminum or copper coating is in direct contact with the substrate.

Aspect 21: A method of making the device of any of the preceding aspects, wherein the device is a luminaire, comprising: providing a non-thermally conducting plastic heat sink having an inner surface and an outer surface, wherein the heat sink has a thermally conductive layer on at least the inner surface of the heat sink; and connecting the heat sink with a substrate comprising at least one LED.

Aspect 22: The method of Aspect 21, further comprising enclosing the substrate in a housing.

Aspect 23: The method of any of Aspects 21-22, wherein the heat sink is formed by injection molding.

Aspect 24: The method of any of Aspects 21-23, wherein the thermally conductive layer is deposited on the heat sink by vacuum metallization, arc and flame spraying or plating, or in-mold decoration.

Aspect 25: The method of any of Aspects 21-24, wherein the inner surface of the heat sink is in direct contact with the substrate.

1. A device comprising:
a substrate comprising at least one LED;
a heat sink comprising a non-thermally conducting plastic component having an inner surface and an outer surface; and
a thermally conductive coating in thermal communication with the substrate on at least the inner surface of the plastic component.

2. The device of claim 1, wherein the thermally conductive coating comprises at least one of zinc, copper, silver, gold, platinum, aluminum, alloys of these metals, or combinations of these metals; preferably the thermally conductive coating comprises aluminum or copper.

3. The device of claim 1, wherein the thermally conductive coating comprises at least one of graphene, boron nitride, or carbon nanotubes.

4. The device of claim 1, wherein substantially all of the thermally conductive coating on the inner surface of the heat sink is in thermal communication with the substrate.

5. The device of claim 1, wherein the substrate is a circuit board.

6. The device of claim 5, wherein the circuit board comprises a single layer.

7. The device of claim 1, wherein substantially all of the thermally conductive coating on the inner surface of the heat sink is in thermal communication with the substrate.

8. The device of claim 1, wherein the thermally conductive coating has an average thickness of 1 μm to 100 μm.

9. The device of claim 1, further comprising a housing having a first major surface and a second major surface, and wherein the heat sink is formed on a portion of the housing.

10. The device of claim 1, wherein the substrate comprises an LED array.

11. The device of claim 1, wherein the device is a luminaire.

12. The device of claim 1, wherein the thermal conductivity of the plastic is 0.01 W/mK to 0.7 W/mK, preferably wherein the thermal conductivity of the plastic is 0.1 W/mK to 0.5 W/mK.

13. The device of claim 1, wherein the plastic is acrylonitrile butadiene styrene.

14. The device of claim 1, further comprising a housing having a first major surface and a second major surface, and wherein the heat sink is formed on a portion of the housing, preferably wherein the housing comprises a plurality of raised structures.

15. The device of claim 1, wherein the inner surface of the heat sink is in direct contact with the substrate, and/or wherein the inner surface of the heat sink is substantially flat, preferably flat.

16. A method of making the device of claim 1, wherein the device is a luminaire, comprising:
providing a non-thermally conducting plastic heat sink having an inner surface and an outer surface, wherein the heat sink has a thermally conductive layer on at least the inner surface of the heat sink; and
connecting the heat sink with a substrate comprising at least one LED.

17. The method of claim 16, further comprising enclosing the substrate in a housing.

18. The method of claim 16, wherein the heat sink is formed by injection molding.

19. The method of claim 16, wherein the thermally conductive layer is deposited on the heat sink by vacuum metallization, arc spraying or plating, flame spraying or plating, or in-mold decoration.

20. The method of claim 16, wherein the inner surface of the heat sink is in direct contact with the substrate.
